(19) United States
(12) Patent Application Publication
(10) Pub. No.: US 2020/0336882 A1
(43) Pub. Date: Oct. 22, 2020

(54) EMERGENCY ON-DUTY ARRANGEMENT METHOD

(71) Applicant: Beijing Yutian Technology Co.Ltd, Beijing (CN)

(72) Inventor: Libao YAN, Beijing (CN)

(21) Appl. No.: 16/687,674

(22) Filed: Nov. 18, 2019

(30) Foreign Application Priority Data
Apr. 17, 2019 (CN) 201910306982.X

(51) Int. Cl. H04W 4/90; H04M 3/51; H04L 29/08; H04W 76/50

(52) U.S. Cl. CPC H04W 4/90; H04W 76/50; H04L 67/306; H04M 3/5116

(57) ABSTRACT

The present invention discloses an emergency on-duty arrangement method, used to deal with the stalemate that during the emergency duty in the emergency communication industry at present, on-duty arrangement needs to finish manually by means of paper or forms, and the relevant staff are notified manually by phone calls or emails after the completion of the shift arrangement, resulting in problems such as unclear shifts, overlapped and repeated responsibilities and unclear division of labor during personnel scheduling, which seriously affects the efficiency of emergency on-duty management, the method realizes the automatic on-duty arrangement of the system and automatic sending of notifications to the relevant on-duty personnel, and improves the efficiency of emergency duty management. It includes on-duty setting, on-duty personnel management, on-duty arrangement, on-duty query statistics, on-duty table reporting, on-duty table approval, on-duty notifications, on-duty logs and so on.

### TECHNICAL FIELD

The present invention relates to the field of emergency management, in particular to an emergency on-duty arrangement method.

### BACKGROUND ART

Public security is the cornerstone of national security and social stability. Many units and institutions attach great importance to emergency management of public emergency events. With the establishment of government emergency management organization system, and the gradual perfection of related laws, regulations, rules and norms of emergency management, emergency work is facing changes. In order to prevent and reduce public emergencies and damage arising therefrom to a great extent, improve the ability of the people's government to ensure public safety and deal with public emergencies, improve the ability to dispose public emergencies, and prevent and resolve public emergencies timely, all units of the government have also formulated emergency on-duty management systems and on-duty plans. However, as the core of emergency duty—the on-duty arrangement, is still conducted manually by means of paper or forms. The relevant staff are notified manually by phone calls and emails after the completion of the shift arrangement, resulting in problems such as unclear shifts, overlapped and repeated responsibilities and unclear division of labor during personnel scheduling, which seriously affects the efficiency of emergency on-duty management.

### CONTENTS OF THE INVENTION

In view of the stalemate that during the emergency duty in the emergency communication industry at present, on-duty arrangement needs to finish manually by means of paper or forms, and the relevant staff are notified manually by phone calls or emails after the completion of the shift arrangement, resulting in problems such as unclear shifts, overlapped and repeated responsibilities and unclear division of labor during personnel scheduling, which seriously affects the efficiency of emergency on-duty management, the present invention provides an emergency on-duty arrangement method to realize automatic on-duty arrangement and automatic sending of notifications to relevant on-duty personnel, improving the efficiency of emergency on-duty management.

The present invention is realized by the following technical scheme: an emergency on-duty arrangement method includes:

Step 1: On-duty settings. The on-duty calendar and on-duty rules are set first, including adjusting the default calendar of the system, marking special festivals and holidays and important guarantee period, presetting the on-duty staffing and on-duty arrangement rules.

Step 2: On-duty personnel management. For the management of on-duty personnel of the unit, it is required to initialize the on-duty personnel information of the unit, including the name, work unit, post, gender, mobile phone number and on-duty phone. On-duty personnel information can be input manually or imported.

Step 3: On-duty arrangement. Shift arrangement can be conducted after the on-duty arrangement rules and on-duty personnel are set correctly. The on-duty arrangement can be conducted for a designated month, and the default on-duty arrangement is the on-duty situation of next month. The shift arrangement method is divided into automatic arrangement and manual arrangement. In view of the automatic arrangement, the on-duty personnel for each on-duty day next month are automatically assigned according to the relevant settings in the “On-duty Setting”. The separate arrangement or adjustment is made for designated on-duty dates by manual arrangement, and the manual arrangement has higher priority than the automatic arrangement.

Step 4: On-duty table query. After the completion of the on-duty arrangement, the current and historical shift arrangement, the on-duty status in months, and the on-duty details of the unit and its affiliated units can be seen. Meanwhile, the on-duty information for a designated time period through the export function can be exported, and the on-duty table can be printed.

Step 5: On-duty table reporting. The on-duty arrangement results are reported to the leader in charge for approval.

Step 6: Examination and approval of on-duty tables. The leader in charge notifies the on-duty personnel of the on-duty information by means of text messages, WeChat or e-mail after examining and verifying the current on-duty table.

Step 7: On-duty log management. Various situations happening the day on duty are recorded, including information receiving, event reporting and other emergencies.

Furthermore, the on-duty setting mentioned also includes the type configuration of on-duty personnel, such as shift leaders and duty officers. The on-duty rule setting is configured based on the on-duty type (working days, festivals, holidays and special periods), on-duty shifts (day shift and night shift), staffing (shift leaders and duty officers), on-duty time and other conditions.

Furthermore, the on-duty personnel mentioned also includes importing the on-duty personnel from emergency address books and designing the structure of tables on the database server, including on-duty personnel tables, tables for emergency address book and relational tables.

Furthermore, the on-duty arrangement mentioned also includes the readjustment according to the actual situation to prevent temporary changes of the duty personnel after the completion of automatic arrangement.

Furthermore, the on-duty query mentioned also includes on-duty statistics. Users can make statistics of the on-duty type and the number of on-duty shifts in a designated period of time. The statistical results can be shown in the form of lists and views, and also can be exported.

Furthermore, the on-duty examination and approval mentioned also includes returning to the on-duty arrangement for revision if not approved and submitting again, or pushing the on-duty arrangement to the emergency portal site if approved.

Compared with the existing technology, the present invention has the following advantages and beneficial effects:

The present invention aims to deal with the stalemate that during the emergency duty in the emergency communication industry at present, on-duty arrangement needs to finish manually by means of paper or forms, and the relevant staff are notified manually by phone calls or emails after the completion of the shift arrangement, resulting in problems such as unclear shifts, overlapped and repeated responsibilities and unclear division of labor during personnel scheduling, which seriously affects the efficiency of emergency on-duty management, the method realizes the automatic on-duty arrangement of the system and automatic sending of notifications to the relevant on-duty personnel, and improves the efficiency of emergency duty management.

### BRIEF DESCRIPTION OF DRAWINGS

In order to make contents of the present invention understood more easily and clearly, the present invention is further described in detail in accordance with specific embodiments of the present invention and figures, where

FIG. 1 shows a flowchart of an emergency on-duty arrangement in an embodiment of the present invention.

### EMBODIMENTS

The following contents are detailed descriptions for embodiments of the present invention combined with figures. The following embodiments are used to describe the present invention but are not used to limit the scope of the present invention.

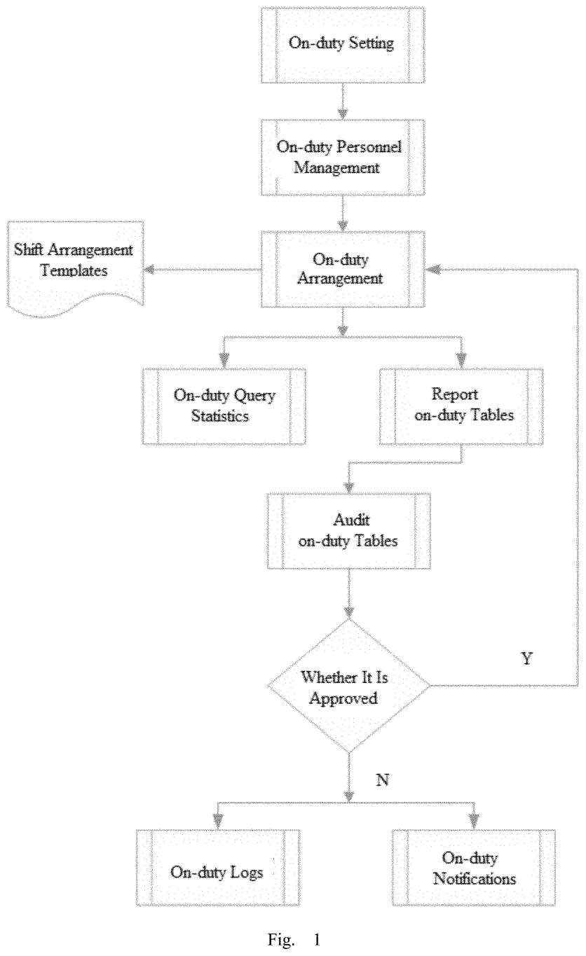

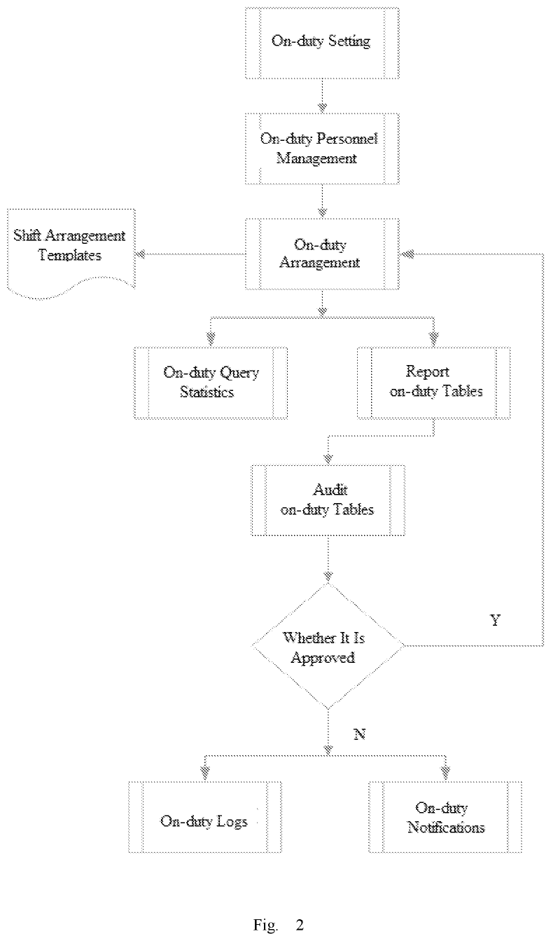

FIG. 1 shows a flowchart of an emergency on-duty arrangement method provided by the present invention. The flowchart of the method includes on-duty setting, on-duty personnel management, on-duty arrangement, on-duty query statistics, on-duty table reporting, examination and approval of on-duty tables, on-duty logs, on-duty notifications, etc.

On-Duty Setting: Establish the on-duty calendar and shift arrangement rule table. The default one-year on-duty calendar is generated based on the calendar control. Adjust the default calendar of the system and mark special holidays (such as Mid-Autumn Festival, Dragon Boat Festival, etc.) and important guarantee periods (such as the two sessions, military parade, etc.). The on-duty rules are set by configuring on-duty cycles, on-duty staffing, on-duty types, on-duty shifts and other conditions. The details are as follows:

(1) The priority level of shift arrangement: Important guarantee period>festivals and holidays>weekends>working days, that is, the high priority on-duty arrangement can cover the low priority (making statistics of on-duty situations according to the high priority).

(2) On-duty types are distinguished by color: Four on-duty types “important period, festivals and holidays, weekends” (if weekends are filled with the default color in the calendar control, then the background color is deepened for distinction), and normal” are distinguished by four different background colors.

(3) On-duty types: The day shift and night shift are marked with icons.

(4) On-duty shifts: Include the day shift and night shift.

(5) Staffing: One of the shift leader or duty officer or the both can go on duty at the same time.

On-duty Personnel Management: In view of the management of on-duty personnel of the unit, establish a list of on-duty personnel and initialize the information of on-duty personnel, including the name, work unit, position, gender, mobile phone and on-duty phone. On-duty personnel information can be input manually, or imported from Excel or emergency address book. Preset the standard format for Excel tables, collect information of on-duty personnel of the unit, and then import in batches; the import of the emergency address book needs to connect with the emergency command platform, and access the information of on-duty personnel as the attribute in the emergency address book through a unified interface.

On-duty Arrangement: Establish on-duty arrangement, on-duty personnel and shift arrangement relational table and store current and historical shift arrangement. Shift arrangement can be conducted for on-duty personnel after the on-duty setting and the initialization of on-duty personnel. The shift arrangement can be conducted for a designated month, and the default on-duty arrangement is the on-duty situation of next month. The shift arrangement method is divided into automatic arrangement and manual arrangement. In view of the automatic arrangement, the on-duty personnel for each on-duty day the current month are automatically assigned according to the relevant settings in the “On-duty Setting”. Moreover, the post of the duty leader is higher than that of the duty officer. The separate arrangement or adjustment is made for designated on-duty dates by manual arrangement, and the manual arrangement has higher priority than the automatic arrangement. The readjustment is made according to the actual situation to prevent temporary changes of the on-duty personnel after the completion of automatic arrangement.

On-duty Query Statistics: After the completion of the on-duty arrangement, the current and historical shift arrangement, the on-duty status in months, and the on-duty details of the unit and its subordinate units can be seen. Meanwhile, the on-duty information for a designated time period through the export function can be exported, and the on-duty table can be printed. Statistical queries can be made on the emergency duty according to the work unit and on-duty date. Statistical results can be classified and displayed according to normal duty, festival and holiday duty, and special period duty. The system supports the export of statistical results and the exported statistical tables with fields such as names, posts, work units, on-duty types, shifts and total number, of which the statistics of on-duty number is made according to the on-duty type of important guarantee period, festivals and holidays, weekends, working days. The on-duty number is counted according to day shift and night shift. The top ranks of the total on-duty number, the top ranks of the workday duty, the top ranks of the holiday duty and weekend duty, and the top ranks of the number of important guarantee period duty can be counted.

On-duty Table Reporting: Establish the flow chart of on-duty examination and approval, record the information of on-duty reporting process, and report the results of on-duty arrangement to the leader in charge for approval. The reporting party can check the approval status and approval time of the leader in charge.

Examination and approval of On-duty Tables: The leader in charge examines and confirms the reported on-duty situation, and can check the detailed on-duty information, including the on-duty personnel, on-duty time, on-duty type, etc. Approval nodes are divided into approved and not approved. The on-duty arrangement begins to take effect after the approval. If not approved, the leader in charge gives the relevant opinions and the approval process returns to the on-duty arrangement node for revision and re-submission for approval. The information of on-duty approval process is recorded in the on-duty approval flow chart.

On-duty Notifications: The on-duty information is notified to the on-duty personnel by means of text message, WeChat or e-mail after the approval. The text message notification needs to be sent by calling the text message platform interface, the WeChat notification needs to be sent by calling the WeChat interface, the email notification needs to be sent by calling the email gateway interface, and the notification content of sending on-duty tables is automatically generated. An on-duty notification table is established to record the time, personnel and way of notifications.

On-duty Logs: A duty log table is established to record all kinds of situations happening on the day on duty, including information receiving, event reporting and other emergencies.

1. An emergency on-duty arrangement method is characterized in that shown in the following steps:
Step 1: On-duty settings, The on-duty calendar and on-duty rules are set first, including adjusting the default calendar of the system, marking special festivals and holidays and important guarantee period, presetting the on-duty staffing and on-duty arrangement rules;
Step 2: On-duty personnel management, For the management of on-duty personnel of the unit, it is required to initialize the on-duty personnel information of the unit, including the name, work unit, post, gender, mobile phone number and on-duty phone, On-duty personnel information can be input manually or imported;
Step 3: On-duty arrangement, Shift arrangement can be conducted after the on-duty arrangement rules and on-duty personnel are set correctly, The on-duty arrangement can be conducted for a designated month, and the default on-duty arrangement is the on-duty situation of next month, The shift arrangement method is divided into automatic arrangement and manual arrangement. In view of the automatic arrangement, the on-duty personnel for each on-duty day next month are automatically assigned according to the relevant settings in the “On-duty Setting”, The separate arrangement or adjustment is made for designated on-duty dates by manual arrangement, and the manual arrangement has higher priority than the automatic arrangement;
Step 4: On-duty table query, After the completion of the on-duty arrangement, the current and historical shift arrangement, the on-duty status in months, and the on-duty details of the unit and its affiliated units can be seen, Meanwhile, the on-duty information for a designated time period through the export function can be exported, and the on-duty table can be printed;
Step 5: On-duty table reporting, The on-duty arrangement results are reported to the leader in charge for approval;
Step 6: Examination and approval of on-duty tables, The leader in charge notifies the on-duty personnel of the on-duty information by means of text messages, WeChat or e-mail after examining and verifying the current on-duty table;
Step 7: On-duty logs, All kinds of situations happening the day on duty are recorded, including information receiving, event reporting and other emergencies.

2. The emergency on-duty arrangement method described in the claim 1, is characterized in that the on-duty setting mentioned also includes the type configuration of on-duty personnel, such as shift leaders and duty officers, the on-duty rule setting is configured based on the on-duty type (working days, festivals, holidays and special periods), on-duty shifts (day shift and night shift), staffing (shift leaders and duty officers), on-duty time and other conditions.

3. The emergency on-duty arrangement method described in the claim 1, is characterized in that the management of the on-duty personnel mentioned also includes importing the on-duty personnel information from emergency address books and designing the structure of tables on the database server, including on-duty personnel tables, tables for emergency address book and relational tables.

4. The emergency on-duty arrangement method described in the claim 1, is characterized in that the on-duty arrangement mentioned also includes the readjustment according to the actual situation to prevent temporary changes of the on-duty personnel after the completion of automatic arrangement.

5. The emergency on-duty arrangement method described in the claim 1, is characterized in that the on-duty query mentioned also includes on-duty statistics, users can make statistics of the on-duty type and the number of on-duty shifts in a designated period of time, The statistical results can be shown in the form of lists and views, and also can be exported.

6. The emergency on-duty arrangement method described in the claim 1, is characterized in that the on-duty examination and approval mentioned also includes returning to the on-duty arrangement for revision if not approved and submitting again, or pushing the on-duty arrangement to the emergency portal site if approved.
